(19) United States
(12) Patent Application Publication
(10) Pub. No.: US 2025/0308392 A1
(43) Pub. Date: Oct. 2, 2025

(54) DYNAMIC FLIGHT PATH RECOMMENDATION

(71) Applicant: HONEYWELL INTERNATIONAL INC., Charlotte, NC (US)

(72) Inventors: Kalimulla Khan, Bangalore (IN); Kirupakar J, Madurai (IN); Ramkumar Rajendran, Madurai (IN)

(21) Appl. No.: 18/621,403

(22) Filed: Mar. 29, 2024

(51) Int. Cl. G08G 5/00; G06F 18/23; G06F 18/25; G08G 5/04

(52) U.S. Cl. CPC G08G 5/34; G06F 18/23; G06F 18/25; G08G 5/80

(57) ABSTRACT

Techniques for generating flight path recommendations for an aircraft. In operation, an alternative flight path indication for generating a flight path recommendation may be received. Upon receiving the alternative flight path indication, avionics data for the aircraft, contextual flight operations data for the aircraft, and flight operation modelled data associated with a plurality of flight paths corresponding to the current flight operation of the aircraft are obtained. The avionics data, the contextual flight operation data, and the flight operation modelled data are then combined to generate a fused aviation data set. The fused aviation data set is then analyzed using a flight path recommendation model to generate a flight path recommendation. The flight path recommendation is then applied to the current flight operation of the aircraft.

### BACKGROUND

Aircraft flight operations are generally controlled based on instructions received from various Air Traffic Control (ATC) towers situated near aerodromes along with other ATC centers. For instance, an ATC tower may communicate preflight information that may include a flight path and weather forecast corresponding to the flight path to an aircraft before the aircraft takes off from the ground. Once the aircraft takes off and leaves the ATC tower's airspace, the aircraft may enter an Air route traffic control center's (ARTCC) airspace. While the aircraft passes through the ARTCC's airspace, the aircraft may be monitored and provided with in-air information to the aircraft, where the in-air information includes updated weather and air-traffic information. In some situations, the ARTCC may also suggest alternative flight paths to the aircraft in view of the updated weather and air-traffic information. Further, when the aircraft is about to land, the aircraft may enter another ATC tower's airspace, where the other ATC tower may communicate clearance for landing and direct pilots through taxiways.

### BRIEF DESCRIPTION OF DRAWINGS

FIG. 1 illustrates an environment for implementing a flight path recommendation system, in accordance with an example of the present subject matter,

FIG. 2 illustrates a schematic of the flight path recommendation system, in accordance with an example of the present subject matter,

FIG. 3 illustrates the schematic of the flight path recommendation system, in accordance with another example of the present subject matter,

FIG. 4 illustrates a method for generating flight path recommendations for an aircraft, in accordance with an example of the present subject matter,

FIG. 5 illustrates a method for generating flight path recommendations for an aircraft, in accordance with another example of the present subject matter,

FIG. 6 illustrates a method for generating flight path recommendations for an aircraft, in accordance with yet another example of the present subject matter,

FIG. 7 illustrates a method for obtaining ATC approval for a flight path recommendation, in accordance with an example of the present subject matter,

FIG. 8 illustrates a method for obtaining ATC approval for a flight path recommendation, in accordance with another example of the present subject matter, and

FIG. 9 illustrates a non-transitory computer-readable medium for generating flight path recommendations for an aircraft, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

An ARTCC typically utilizes the information received from different satellites for identification of adverse flight conditions in the flight path for the aircraft and recommends alternative flight paths to the aircraft. The alternative flight paths are usually recommended upon receiving a request for alternative flight paths from a pilot of the aircraft. Such requests are usually received from the pilot when the pilot anticipates a flight safety hazard on an original flight path of the aircraft. Upon receiving the request, an air traffic controller at the ARTCC manually identifies the alternative flight paths based on the analysis of the updated weather and air-traffic information. The ARTCC subsequently communicates the identified alternative flight paths to the pilot.

As the alternative flight paths are identified manually by the air traffic controllers stationed at the ARTCC, the accuracy of the identified alternative flight paths is subject to the experience and skillset of the air traffic controller and thus, is prone to errors. Further, as the alternative flight paths are identified at the ARTCC and subsequently communicated to the aircraft, such techniques for identification of the alternative flight paths involve delays corresponding to the transmission of the request for alternative flight paths from the pilot to the ARTCC, identification of the alternative flight paths at the ARTCC, and reception of the identified alternative flight paths in response to such a request.

In addition, conventional methods for identification of the alternative flight paths are limited to identification of the alternative flight paths to avoid flight safety hazards, such as adverse weather conditions, and do not consider identification of alternative flight paths with respect to other aspects affecting a current flight operation of the aircraft, such fuel consumption and flight time involved in the current flight operation of the aircraft.

According to examples of the present subject matter, techniques for providing dynamic flight path recommendations for an aircraft are disclosed.

In an example implementation, an alternative flight path indication for generating a flight path recommendation may be received, where the flight path recommendation may correspond to a current flight operation of the aircraft. Upon receiving the alternative flight path indication, avionics data from various avionics systems available onboard the aircraft may be received. The avionics data may be received in accordance with a category of flight path recommendation to be provided. For instance, avionics data required for providing a flight path recommendation for a shortcut advisory may be different from the avionics data required for providing a flight path recommendation for avoiding a weather hazard.

Thereafter, contextual flight operation data for the aircraft may be received. The contextual flight operation data may be indicative of an aviation context corresponding to a current flight operation of the aircraft. For instance, the contextual flight operation data may include at least one of flight planning and dispatch data, weather data, wind data, air traffic data, NOTAM data, runway data corresponding to the runways at the source and destination airports, and navigational data. In an example, the contextual flight operation data may be received from at least one aviation cloud service. Further, the contextual flight operations data may be obtained in accordance with a category of the flight path recommendation.

Subsequently, flight operation modelled data associated with a plurality of flight paths corresponding to the current flight operation of the aircraft may be obtained. In an example, the flight operation modelled data may be obtained from at least one avionics digital clone of the avionics systems. The avionics data, the contextual flight operation data, and the flight operation flight operation modelled data may then be combined to generate a fused aviation data set.

Thereafter, the fused aviation data set may be analyzed using a flight path recommendation model that corresponds to the category of flight path recommendation to be provided. The fused aviation data set may be analyzed using the flight path recommendation model to identify a plurality of flight path recommendations for the aircraft. In an example, the flight path recommendation model may be trained based on historical flight operations data related to the category of the flight path recommendation. For instance, when the category of flight path recommendation is shortcut advisory, the flight path recommendation model may be trained based on the historical flight operations data related to the shortcut advisory. A flight path recommendation from the plurality of flight path recommendations may then be applied to the current flight operation of the aircraft.

As the data being analyzed for generation of flight path recommendations is obtained categorically for different categories of flight path recommendations, the flight path recommendations are generated by analyzing data relevant to different categories. Accordingly, the accuracy involved in generation of the flight path recommendations is improved.

Further, by generating the flight path recommendations in the manner described above, the amount of data to be analyzed for generation of the flight path recommendations is also reduced. Therefore, the present subject matter entails consumption of fewer computational resources in generation of the flight path recommendation, thereby allowing implementation of such techniques on Electronic Flight Bags (EFB) onboard the aircraft.

Further, as the present subject matter is not limited to generation of the flight path recommendation for avoiding flight safety incidents and allows generation of flight path recommendations corresponding to various other categories, such as shortcut advisory and flight level advisory, the present subject matter facilitates reduction in consumption of aviation fuel and flight time associated with flight operations of the aircraft, thereby optimizing the flight operations of the aircraft.

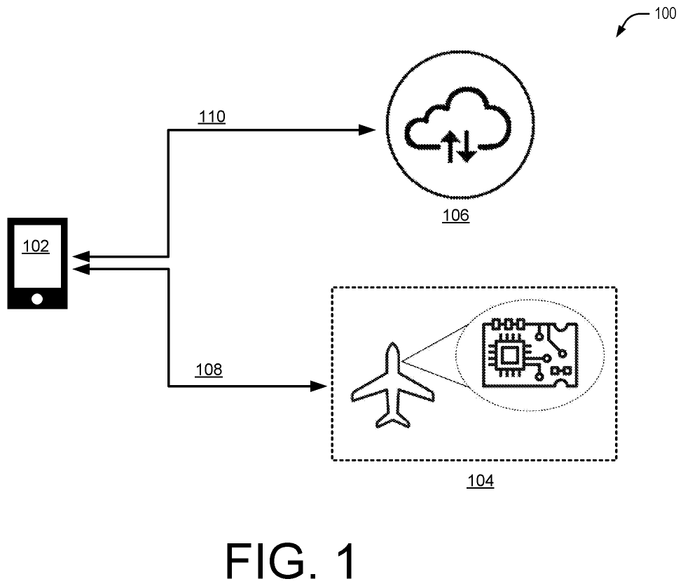

The above techniques are further described with reference to FIGS. 1 to 9. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment 100 for implementing a flight path recommendation system 102, in accordance with an example of the present subject matter. Examples of the environment 100 may include, but are not limited to, aircraft, Air Traffic Control (ATC) tower, and Air Route Traffic Control Center (ARTCC).

In an example, the flight path recommendation system 102 may be configured to generate flight path recommendations for the aircraft. Examples of flight path recommendation system 102 may vary depending on the environment 100 where the flight path recommendation system is being implemented. For instance, when the environment 100 is aircraft, examples of flight path recommendation system 102 may include, but are not limited to, Electronic Flight Bag (EFB) and on-board Flight Management System (FMS). On the other hand, when the environment 100 is ATC tower or ARTCC, examples of flight path recommendation system 102 may include, but are not limited to, laptops, desktops, smartphones, and tablets.

The environment 100 may further include avionics systems available onboard the aircraft, where the avionics systems may be communicatively coupled to the flight path recommendation system 102. Examples of the avionics systems 104 include, but are not limited to, Flight Management System (FMS), Enhanced Ground Proximity Warning Systems (EGPWS), RADAR, Auxiliary Power Unit (APU), Engine, Wheels, and Brakes. In an example, the avionics systems 104 may communicate avionics data for the aircraft to the flight path recommendation system 102.

Further, the environment 100 may include various aviation cloud services communicatively coupled to the flight path recommendation system 102. In an example, the aviation cloud services may facilitate retrieval of contextual flight operation data for the aircraft. In the example, the contextual flight operation data may be indicative of an aviation context corresponding to a current flight operation of the aircraft. Further, such aviation cloud services may communicate the contextual flight operation data to the flight path recommendation system 102.

The flight path recommendation system 102 may communicate with the avionics systems 104 and the aviation cloud services 106 via different communication networks. For instance, the flight path recommendation system 102 may communicate with the avionics systems 104 via first communication network 108. The first communication network 108 can be a wireless or a wired network, or a combination thereof. Further, the first communication network 108 can be a collection of individual networks, interconnected with each other and functioning as a single large network. Examples of the first communication network 108 may vary depending on the environment 100 where the flight path recommendation system is being implemented. For instance, when the environment 100 is aircraft, the first communication network 108 may include onboard Wi-Fi. On the other hand, when the environment is ATC tower or ARTCC, the first communication network 108 may include a combination of satellite communication and the onboard Wi-Fi.

Further, the flight path recommendation system 102 may communicate with the aviation cloud services via the second communication network 110. The second communication network 110 can be a wireless or a wired network, or a combination thereof. Further, the second communication network 110 can be a collection of individual networks, interconnected with each other and functioning as a single large network. Examples of the second communication network 110 may vary depending on the environment 100 where the flight path recommendation system is being implemented. For instance, when the environment 100 is the aircraft, the second communication network 110 may include satellite communication (SATCOM). On the other hand, when the environment 100 is the ATC tower or ARTCC, the second communication network 110 may be Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), Integrated Services Digital Network (ISDN), or a combination thereof.

In operation, the flight path recommendation system 102 may receive an alternative flight path indication for generating a flight path recommendation. The flight path recommendation system 102 may receive the alternative flight path indication during a current flight operation of the aircraft. The current flight operation of the aircraft may be considered as a flight of the aircraft between a source airport and a destination airport. In an example, the flight path recommendation system 102 may receive a user input indicating a request for a flight path recommendation. Such a user input may be received from different users. For instance, when the environment 100 is aircraft, the user input may be received from a pilot. On the other hand, when the environment 100 is the ATC tower, the user input may be received from an air traffic controller stationed at the ATC tower. In another example, the alternative flight path indication may be a flight safety hazard on a flight path corresponding to the current flight operation of the aircraft. The flight safety hazard may be indicative of a condition or an event that has the potential to cause harm or disrupt safe flight operations. Examples of the flight safety hazards may include, but are not limited to, thunderstorms, turbulence, fog and low visibility, hurricanes and tornadoes, volcanic ash, bird strikes, runway contamination, and air traffic congestion.

Upon detecting the alternative flight path indication, the flight path recommendation system 102 may obtain avionics data from the avionics systems available onboard the aircraft. Further, the avionics data may be obtained in accordance with a category of flight path recommendation. Examples of the category of flight path recommendation include, but are not limited to, flight safety hazard avoidance advisory, shortcut advisory, and fuel saving advisory.

The category of flight path recommendation may be determined based on the alternative flight path indication. For instance, when the alternative flight path indication is flight safety hazard on the flight path corresponding to the current flight operation of the aircraft, the category of flight path recommendation may be determined to be flight safety hazard avoidance advisory. On the other hand, when the alternative flight path indication is the user input, such as an input from the pilot of the aircraft for identification of a shortcut to a destination corresponding to the current flight operation of the aircraft, the category of flight path recommendation may be determined to be shortcut advisory.

The flight path recommendation system 102 may identify an avionics Application Programming Interface (API) mashup for obtaining the avionics data from the avionics systems. In an example, the flight path recommendation system 102 may generate and store different API mashups in an API repository. To generate an API mashup, such as the avionics mashup, the flight path recommendation system 102 may collect the API information for a plurality of avionics APIs. The flight path recommendation system 102 may then perform natural language processing (NLP) techniques to the API information to cluster the APIs in a tree structure. The flight path recommendation system 102 may then generate the API mashups based on results of a similarity analysis to determine if APIs in different sub-clusters of the tree structure may be combined. Subsequently, when a request to identify any API mashup corresponding to a category is received, the flight path recommendation system 102 may traverse the API repository and identify an API mashup that is within a threshold similarity to the category and return the identified API mashup.

The flight path recommendation system 102 may subsequently utilize the avionics API mashup to read avionics data corresponding to the category of flight path recommendation from an avionics data bus coupled to the avionics systems 104.

The flight path recommendation system 102 may then receive contextual flight operation data from at least one aviation cloud service from the various aviation cloud services. The contextual flight operation data may be indicative of an aviation context corresponding to the current flight operation of the aircraft. The contextual flight operation data may include at least one of flight planning and dispatch data, weather data, wind data, air traffic data, NOTAM data, runway data corresponding to the runways at the source and destination airports, and navigational data. Further, the flight path recommendation system 102 may obtain the contextual flight operation data in accordance with a category of the flight path recommendation.

In an example, the flight path recommendation system 102 may identify a cloud API mashup corresponding to the category of the flight path recommendation for obtaining the contextual flight operation data from the at least one aviation cloud service. In the example, the cloud API mashup may be generated in the manner similar to that of the avionics mashup. Accordingly, details related to the generation of the cloud API mashup aren't described for the sake of brevity. The flight path recommendation system 102 may subsequently utilize the cloud API mashup to read the contextual flight operation data corresponding to the category of flight path recommendation from the at least one aviation cloud service.

Subsequently, the flight path recommendation system 102 may obtain flight operation modelled data associated with a plurality of flight paths corresponding to the current flight operation of the aircraft. In an example, the flight path recommendation system 102 may obtain the flight operation modelled data from at least one avionics digital clone of the avionics systems. The flight operation modelled data may include aircraft performance predictions including lateral, vertical and speed profile for the aircraft between origin to destination considering at least one of aircraft performance and flight path; fuel calculations including computations of fuel requirements for the flight, taxi fuel, trip fuel, and block fuel, corresponding to the flight path; 4-dimensional trajectory data including position, such as latitude and longitude, altitude, and time predictions along the flight path; take-off and landing computations including take-off and landing speeds, and runway length calculations for the flight path; and flight optimization recommendations including optimization of the flight operation with respect to the flight level, economical speed recommendation, points of deployment of air brakes, flaps, and slats, corresponding to the flight path. Since the flight operation modelled data for the plurality of flight paths varies in accordance with different aircrafts, the flight operation modelled data is obtained by subjecting various flight path characteristics associated with different flight paths to the at least one avionics digital clone of the avionics systems of the aircraft.

The flight path recommendation system 102 may then combine avionics data, the contextual flight operation data, and the flight operation modelled data to generate a fused aviation data set. Subsequently, the flight path recommendation system 102 may analyze the fused aviation data set using a flight path recommendation model to generate a plurality of flight path recommendations. In an example, the flight path recommendation model may correspond to the category of flight path recommendation and may be trained based on historical flight operations data related to the category of flight path recommendation.

The flight path recommendation system 102 may subsequently apply a flight path recommendation from the plurality of flight path recommendations to the current flight operation of the aircraft. The manner in which plurality of flight path recommendations are generated is further explained in conjunction the forthcoming figures.

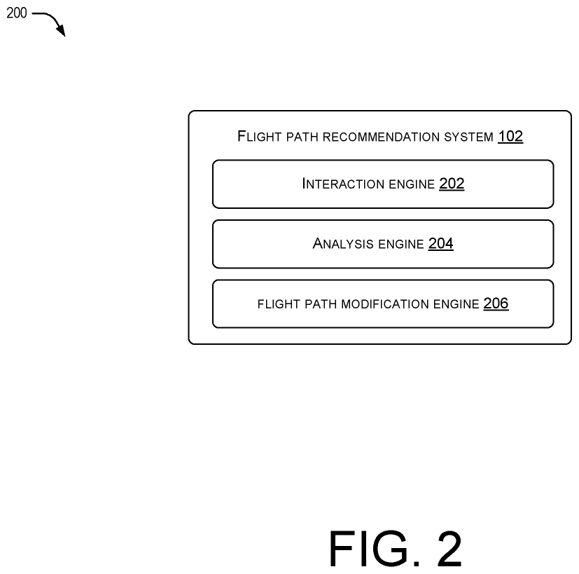

FIG. 2 illustrates a schematic of the flight path recommendation system 102, in accordance with an example of the present subject matter. In an example, the flight path recommendation system 102 may include an interaction engine 202 for receiving a user input for generating a flight path recommendation. In an example, the user input may include a category of the flight path recommendation. As already explained, examples of the category of flight path recommendation include, but are not limited to, shortcut advisory, flight safety hazard avoidance advisory, and fuel saving advisory.

Upon receiving the alternative flight path indication by the interaction engine 202, the analysis engine 204 may obtain the avionics data for the aircraft. The analysis engine 204 may obtain the avionics data from the avionics systems available onboard the aircraft. Further, the analysis engine 204 may obtain the aviation data selectively based on the category of flight path recommendation.

The interaction engine 202 may further receive contextual flight operation data indicative of an aviation context corresponding to the current flight operation of the aircraft. The interaction engine 202 may obtain the contextual flight operation data from the at least one aviation cloud service. Further, the interaction engine 202 may selectively obtain the contextual flight operation data based on the category of the flight path recommendation.

The interaction engine 202 may then obtain flight operation modelled data associated with a plurality of flight paths corresponding to the current flight operation of the aircraft. In an example, the interaction engine 202 may obtain the flight operation modelled data from at least one avionics digital clone of the avionics systems.

The flight path recommendation system 102 may further include an analysis engine 204 coupled to the interaction engine 202. In an example, the analysis engine 204 may combine the avionics data, the contextual flight operation data, and the flight operation flight operation modelled data to generate the fused aviation data set. The analysis engine 204 may subsequently analyze the fused aviation data set using a flight path recommendation model to generate a plurality of flight path recommendations.

In an example, the flight path recommendation model may correspond to the category of flight path recommendation and may have been trained based on the historical flight operations data related to the category of flight path recommendation. In the example, the flight path recommendation model may be a supervised machine learning model. Examples of the flight path recommendation model may include, but are not limited to, Linear Regression, Logistic Regression, Linear Discriminant Analysis, Classification and Regression Trees, Naive Bayes, K-Nearest Neighbors (KNN), Learning Vector Quantization (LVQ), Support Vector Machines (SVM), and Random Forest.

The flight path recommendation system 102 may further include a flight path modification engine 206 coupled to the analysis engine 204. In an example, the flight path modification engine 206 may apply a flight path recommendation from the plurality of flight path recommendations to the current flight operation of the aircraft.

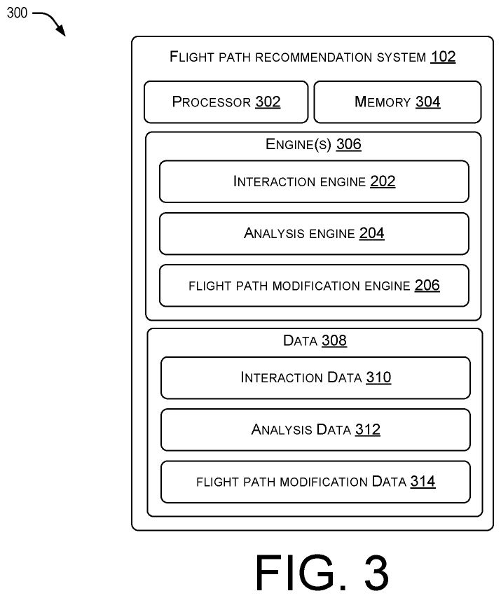

FIG. 3 illustrates a schematic of the flight path recommendation system 102, in accordance with an example of the present subject matter. As already explained, the flight path recommendation system 102 may be configured to generate flight path recommendations for the aircraft.

In an example, the flight path recommendation system 102 includes a processor 302 and a memory 304 coupled to the processor 302. The functions of the various elements shown in the FIGURES, including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The memory 304 may include any computer-readable medium including, for example, volatile memory (e.g., RAM), and/or non-volatile memory (e.g., EPROM, flash memory, etc.).

The flight path recommendation system 102 may further include engine(s) 306, where the engine(s) 306 may include the interaction engine 202, the analysis engine 204, and the flight path modification engine 206. In an example, the flight path recommendation system 102 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the flight path recommendation system 102 may include the machine-readable storage medium storing the instructions and the processing resource to execute the instructions. In other examples of the present subject matter, the machine-readable storage medium may be located at a different location but accessible to flight path recommendation system 102 and the processor 302.

The flight path recommendation system 102 may further include data 308, that serves, amongst other things, as a repository for storing data that may be fetched, processed, received, or generated by the engine(s) 306. In an example, the data 308 may include interaction data 310, analysis data 312, and flight path modification data 314. In an example, the data 308 may be stored in the memory 304.

In an example implementation, the interaction engine 202 may receive the alternative flight path indication to generate a flight path recommendation. In an example, the alternative flight path indication may be received during a current flight operation of the aircraft. Further, the alternative flight path indication may be received in different ways.

In an example, the alternative flight path indication may be received upon detection of a flight safety hazard on a flight path corresponding to the current flight operation of the aircraft. For instance, during the current flight operation, a weather radar available onboard the aircraft may detect adverse weather conditions on the flight path of the aircraft. Upon detecting the adverse weather conditions, the weather radar may send the alternative flight path indication to the interaction engine 202.

In another example, the alternative flight path indication may be a user input. For instance, there may be a situation where a flight may have been delayed from the source airport due to low visibility. In such a situation, the pilot of the aircraft may wish to identify if there exist any shortcuts between the aircraft's current location and the destination to compensate for the delay at the source airport. In such a situation, the pilot of the aircraft may provide the alternative flight path indication for generating the flight path recommendation.

Upon receiving the alternative flight path indication, the interaction engine 202 may obtain the avionics data from various avionics systems available onboard the aircraft. In an example, the avionics data may be obtained in accordance with a category of the flight path recommendation. The category of flight path recommendation may be determined based on the alternative flight path indication. For instance, when the alternative flight path indication is received upon detection of a flight safety hazard the category of flight path recommendation may be determined as weather hazard avoidance advisory. In another example, the category of flight path recommendation may be included in the alternative flight path indication. For instance, when the alternative flight path indication is the user input, such as the user input for identifying shortcuts between the aircraft's current location and the destination airport, the user may provide the category of flight path recommendation as the shortcut advisory.

In an example, the interaction engine 202 may obtain the avionics data corresponding to the category of flight path recommendation by employing an avionics API mashup corresponding to the category of the flight path recommendation. In an example, the interaction engine 202 may employ the avionics API mashup to read the avionics data from the avionics data bus coupled to the avionics systems 104. The interaction engine 202 may subsequently store the avionics data in the interaction data 310.

The interaction engine 202 may then receive the contextual flight operation data indicative of aviation context corresponding to the current flight operation of the aircraft. The interaction engine 202 may receive the contextual flight operation data from at least one aviation cloud service from various aviation cloud services. Further, the interaction engine 202 may receive the contextual flight operation data in accordance with a category of the flight path recommendation. In an example, the interaction engine 202 may employ a cloud API mashup corresponding to the category of the flight path recommendation to communicate with the at least one aviation cloud service and receive the contextual flight operation data.

In an example, to identify and receive the contextual flight operation data, the interaction engine 202 may utilize parameters, such as details of the current flight operation and geographical location of the aircraft, included in the avionics data. For instance, the interaction engine 202 may transmit the details of the current flight operation and the geographical location along with a request to obtain the contextual flight operation data to the at least one aviation cloud service. Upon receiving the request including the details of the current flight operation and the geographical location of the aircraft, the at least one aviation cloud service may identify the contextual flight operation data for the aircraft and transmit such contextual flight operation data to the interaction engine 202. The interaction engine 202 may subsequently store the contextual flight operation data in the interaction data 310.

It would be noted that there may be a plurality of flight paths corresponding to the current flight operation of the aircraft. Accordingly, the aircraft may utilize any one of such plurality of flight paths for flying from the source airport to the destination airport. In an example, each of these flight paths may have different flight path characteristics associated therewith. Accordingly, the operation of the aircraft may vary in accordance with each flight path. The operation of the aircraft may also vary in accordance with flight characteristics of the aircraft, such as size of the aircraft, type of propulsion, minimum turning radius, minimum circling radius, speed of the aircraft, capacity of the aircraft, aircraft weight and wheel configuration, and jet blast. In an example, to account for the different flight path characteristics and the flight characteristics of the aircraft, flight operation modelled data for the aircraft may be generated for the plurality of flight paths corresponding to the current flight operation of the aircraft. In the example, the flight operation modelled data for the aircraft may be generated by subjecting the different flight path characteristics to at least one avionics digital clone of the avionics systems of the aircraft.

In an example, the interaction engine 202 may obtain flight operation modelled data associated with a plurality of flight paths corresponding to the current flight operation of the aircraft. The interaction engine 202 may obtain the flight operation modelled data from the avionics digital clones of the avionics systems available onboard the aircraft. The interaction engine 202 may then store the flight operation modelled data in the interaction data 310.

Subsequently, the analysis engine 204 may combine the avionics data, the contextual flight operation data, and the flight operation modelled data from the interaction data 310 to generate a fused aviation data set. The analysis engine 204 may then store the fused aviation data set in the analysis data 312.

The analysis engine 204 may then analyze the fused aviation data set using a flight path recommendation model corresponding to the category of flight path recommendation to generate a plurality of flight path recommendations. In an example, plurality of flight path recommendations may be generated with flight path parameters associated therewith. The flight path parameters may include at least one of flight time, fuel consumption, and ATC approval confidence score corresponding to the plurality of flight path recommendations. The ATC approval confidence score may be indicative of chances of approval of the flight path recommendation by the ATC.

The flight path recommendation model may be trained based on the historical flight operations data related to the category of flight path recommendation. In an example, to train the flight path recommendation model corresponding to a category of flight path recommendation, the analysis engine 204 may identify a cloud API mashup corresponding to the category of the flight path recommendation. In the example, the cloud API mashup may be generated by clustering APIs based on processing of API information for a plurality of APIs. The analysis engine 204 may then employ the cloud API mashup for retrieving the historical flight operations data from a plurality of data sources, where the plurality of data sources may include historical flight operations data associated with flight operations corresponding to a plurality of aircrafts. The analysis engine 204 may subsequently train the flight path recommendation model based on the historical flight operations data related to the category of flight path recommendation.

For instance, to train the flight path recommendation model corresponding to shortcut advisory, the analysis engine 204 may identify a cloud API mashup corresponding to the shortcut advisory. The analysis engine 204 may then employ the cloud API mashup for retrieving the historical flight operations data from a plurality of data sources. In an example, the historical flight operations data may be associated with the shortcut advisory. That is, the historical flight operations data may be indicative of various shortcuts taken by the plurality of aircrafts with respect to different fused aviation data set and flight path parameters associated with such shortcuts. The analysis engine 204 may subsequently train the flight path recommendation model based on the historical flight operations data related to the shortcut advisory.

Similarly, to train the flight path recommendation model corresponding to shortcut advisory, the analysis engine 204 may identify a cloud API mashup corresponding to the fuel saving advisory. The analysis engine 204 may then employ the cloud API mashup for retrieving the historical flight operations data from a plurality of data sources. In an example, the historical flight operations data may be associated with the fuel saving advisory. That is, the historical flight operations data may be indicative of various flight operations of the plurality of aircrafts that resulted in fuel savings with respect to different fused aviation data set, and flight path parameters associated with such flight operations. The analysis engine 204 may subsequently train the flight path recommendation model based on the historical flight operations data related to the fuel saving advisory.

It would be noted that by considering the flight operation modelled data, along with the avionics data and the contextual flight operation data, for generating the plurality of flight path recommendations for the aircraft, the analysis engine 204 may be enabled to identify the flight path recommendations that are feasible for adaptation by the aircraft in view of the various flight characteristics.

In an example, the analysis engine 204 may render the plurality of flight path recommendations and flight path parameters associated with the plurality of flight path recommendations. In the example, the analysis engine 204 may select at least one flight path recommendation from the plurality of flight path recommendations and submit the at least one flight path recommendation to an ATC for approval. The analysis engine 204 may select the at least one flight path recommendation in various ways. In an example, the analysis engine 204 may select the at least one flight path recommendation based on a user input. In another example, the analysis engine 204 may select the at least one flight path recommendation based on the ATC approval confidence score. For instance, the analysis engine 204 may determine the ATC approval confidence score for at least one flight path recommendation to be greater than a threshold. Based on the determination, the analysis engine 204 may submit the at least one flight path recommendation to the ATC for approval.

In an example, once the at least one flight path recommendation is approved by the ATC, the analysis engine 204 may apply the approved flight path recommendation to the current flight operation of the aircraft.

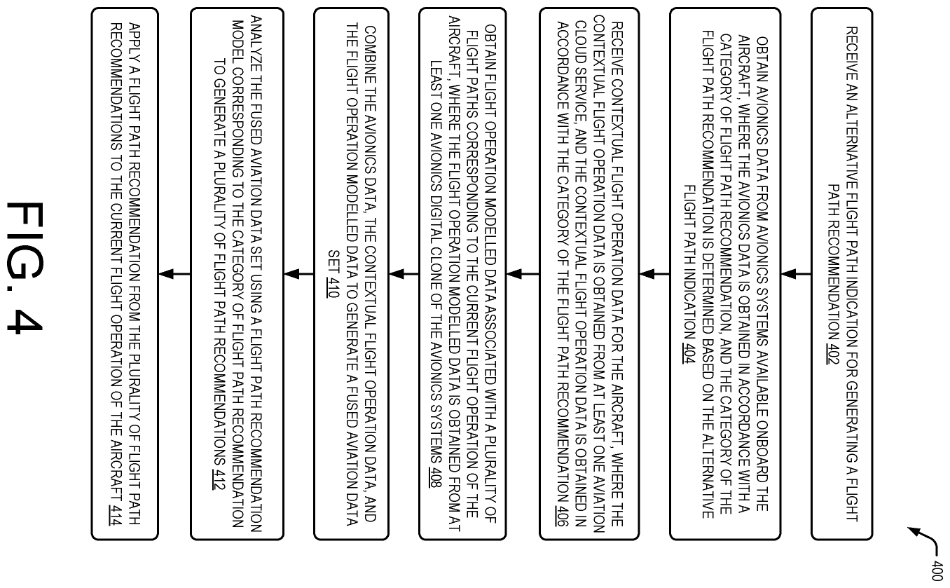

FIGS. 4, 5, and 6 illustrate methods 400, 500, and 600 for generating flight path recommendations for an aircraft, in accordance with examples of the present subject matter. The order in which the methods are described is not intended to be construed as a limitation, and any number of the described method blocks may be combined in any order to implement the methods, or an alternative method. Further, the methods 400, 500, and 600 may be implemented by processing resource or computing device(s) through any suitable hardware, non-transitory machine-readable instructions, or combination thereof.

It may also be understood that methods 400, 500, and 600 may be performed by programmed computing devices, such as the flight path recommendation system 102, as depicted in FIG. 3. Furthermore, the methods 400, 500, and 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 400, 500, and 600 are described below with reference to the flight path recommendation system 102, as described above; other suitable systems for the execution of these methods may also be utilized. Additionally, implementation of the method is not limited to such examples.

In FIG. 4, at block 402, an alternative flight path indication for generating a flight path recommendation may be received. In an example, the alternative flight path indication may be a user input. In another example, the alternative flight path indication may be flight safety hazard on a flight path corresponding to the current flight operation of the aircraft. As explained earlier, the flight safety hazard may be indicative of a condition or an event that has the potential to cause harm or disrupt safe flight operations. Examples of the flight safety hazards may include, but are not limited to, thunderstorms, turbulence, fog and low visibility, hurricanes and tornadoes, volcanic ash, bird strikes, runway contamination, and air traffic congestion. In an example, the alternative flight path indication may be received by the interaction engine 202.

At block 404, avionics data for the aircraft may be obtained from avionics systems available onboard the aircraft. Further, the avionics data may be obtained in accordance with a category of flight path recommendation, where the category of the flight path recommendation is determined based on the alternative flight path indication. In an example, the avionics data may be obtained by the interaction engine 202.

At block 406, contextual flight operation data reflecting the aviation context corresponding to the current flight operation of the aircraft may be obtained. The contextual flight operation data may be obtained from at least one aviation cloud service. Further, the contextual flight operation data may be obtained in accordance with the category of the flight path recommendation. In an example, the contextual flight operation data may be obtained by the interaction engine 202.

Ay block 408, flight operation modelled data associated with a plurality of flight paths corresponding to the current flight operation of the aircraft may be obtained. The flight operation modelled data may be obtained from at least one avionics digital clone of the avionics systems. In an example, the flight operation modelled data may be received by the interaction engine 202.

At block 410, the avionics data, the contextual flight operation data, and the flight operation modelled data may be combined to generate a fused aviation data set. In an example, the avionics data, the contextual flight operation data, and the flight operation modelled data may be combined by the analysis engine 204.

At block 412, the fused aviation data set may be analyzed using a flight path recommendation model corresponding to the category of flight path recommendation. The fused aviation data set may be analyzed to generate a plurality of flight path recommendations. Further, the flight path recommendation model may be trained based on historical flight operations data related to the category of flight path recommendation. In an example, the fused aviation data set may be analyzed by the analysis engine 204.

At block 414, a flight path recommendation from the plurality of flight path recommendations may be applied to the current flight operation of the aircraft. In an example, flight path recommendation may be applied to the current flight operation by the flight path modification engine 206.

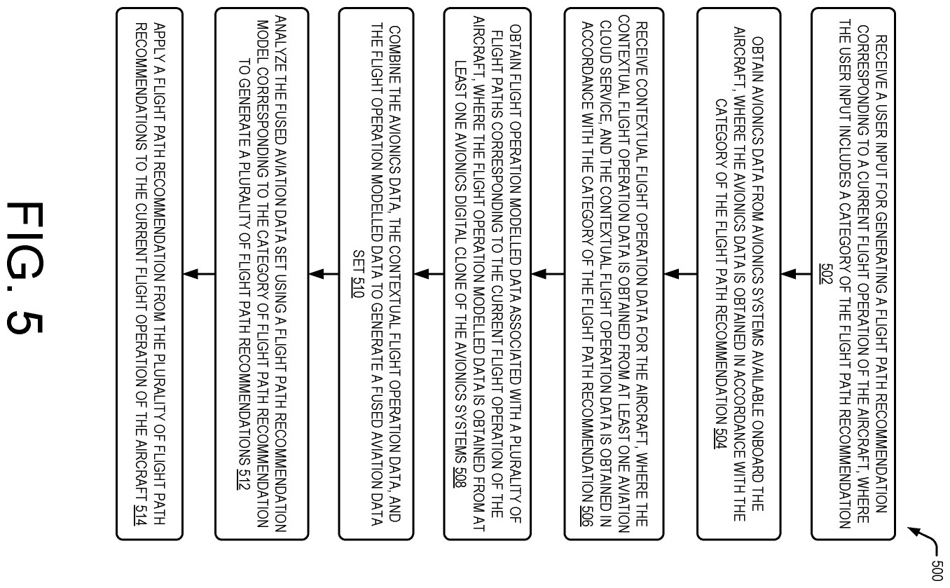

In FIG. 5, at block 502, a user input for generating a flight path recommendation may be received, where the user input includes a category of the flight path recommendation. In an example, the user input may be received by the interaction engine 202.

At block 504, avionics data for the aircraft may be obtained from avionics systems available onboard the aircraft. Further, the avionics data may be obtained in accordance with the category of the flight path recommendation. In an example, the avionics data may be obtained by the interaction engine 202.

At block 506, contextual flight operation data reflecting the aviation context corresponding to the current flight operation of the aircraft may be obtained. The contextual flight operation data may be obtained from at least one aviation cloud service. Further, the contextual flight operations data may be obtained in accordance with the category of the flight path recommendation. In an example, the contextual flight operations data may be obtained by the interaction engine 202.

At block 508, flight operation modelled data associated with a plurality of flight paths corresponding to the current flight operation of the aircraft may be obtained. The flight operation modelled data may be obtained from at least one avionics digital clone of the avionics systems. In an example, the flight operation modelled data may be obtained by the interaction engine 202.

At block 510, the avionics data, the contextual flight operation data, and the flight operation modelled data may be combined to generate a fused aviation data set. In an example, the avionics data, the contextual flight operation data, and the flight operation modelled data may be combined by the analysis engine 204.

At block 512, the fused aviation data set may be analyzed using a flight path recommendation model corresponding to the category of flight path recommendation. The fused aviation data set may be analyzed to generate a plurality of flight path recommendations. Further, the flight path recommendation model may be trained based on historical flight operations data related to the category of flight path recommendation. In an example, the fused aviation data set may be analyzed by the analysis engine 204.

At block 514, a flight path recommendation from the plurality of flight path recommendations may be applied to the current flight operation of the aircraft. In an example, flight path recommendation may be applied to the current flight operation by the flight path modification engine 206.

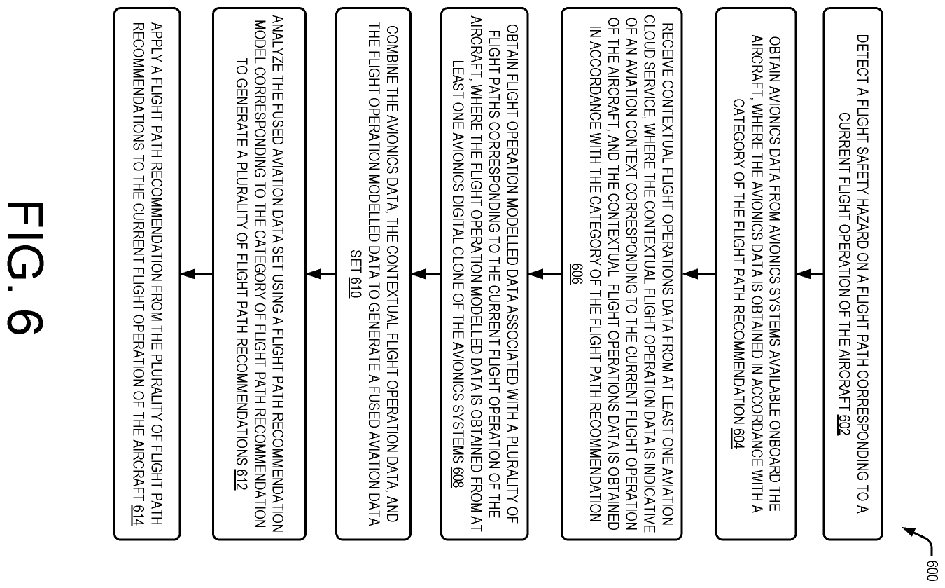

In FIG. 6, at block 602, a flight safety hazard may be detected on a flight path corresponding to a current flight operation of the aircraft. In an example, the flight safety hazard may be detected by the interaction engine 202.

At block 604, avionics data for the aircraft may be obtained from avionics systems available onboard the aircraft. Further, the avionics data may be obtained in accordance with a category of flight path recommendation, where the category of the flight path recommendation is determined based on the flight safety hazard. In an example, the avionics data may be obtained by the interaction engine 202.

At block 606, contextual flight operation data reflecting the aviation context corresponding to the current flight operation of the aircraft may be obtained. The contextual flight operation data may be obtained from at least one aviation cloud service. Further, the contextual flight operation data may be obtained in accordance with the category of the flight path recommendation. In an example, the contextual flight operation data may be obtained by the interaction engine 202.

At block 608, flight operation modelled data associated with a plurality of flight paths corresponding to the current flight operation of the aircraft may be obtained. The flight operation modelled data may be obtained from at least one avionics digital clone of the avionics systems. In an example, the flight operation modelled data may be obtained by the interaction engine 202.

At block 610, the avionics data, the contextual flight operation data, and the flight operation modelled data may be combined to generate a fused aviation data set. In an example, the avionics data, the contextual flight operation data, and the flight operation modelled data may be combined to generate a fused aviation data set may be combined by the analysis engine 204.

At block 610, the fused aviation data set may be analyzed using a flight path recommendation model corresponding to the category of flight path recommendation. The fused aviation data set may be analyzed to generate a plurality of flight path recommendations. Further, the flight path recommendation model may be trained based on historical flight operations data related to the category of flight path recommendation. In an example, the fused aviation data set may be analyzed by the analysis engine 204.

At block 612, a flight path recommendation from the plurality of flight path recommendations may be applied to the current flight operation of the aircraft. In an example, flight path recommendation may be applied to the current flight operation by the flight path modification engine 206.

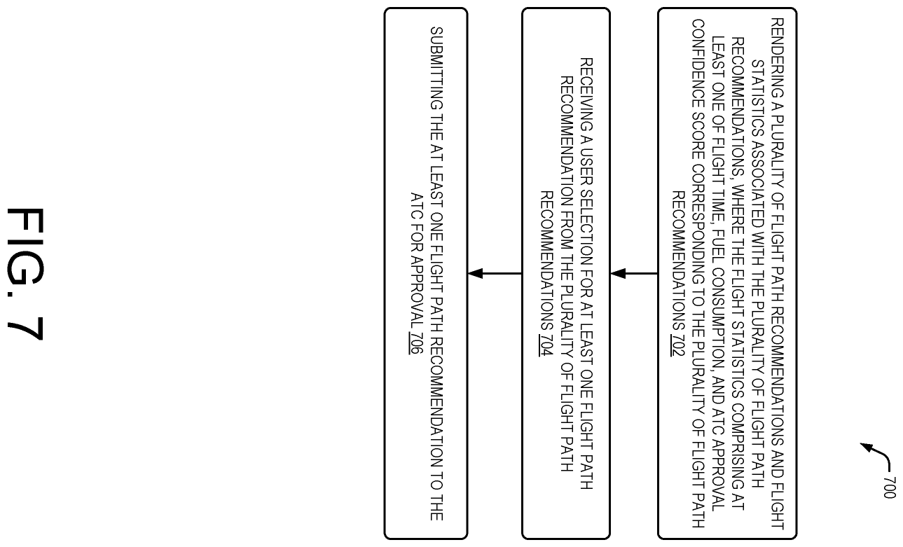

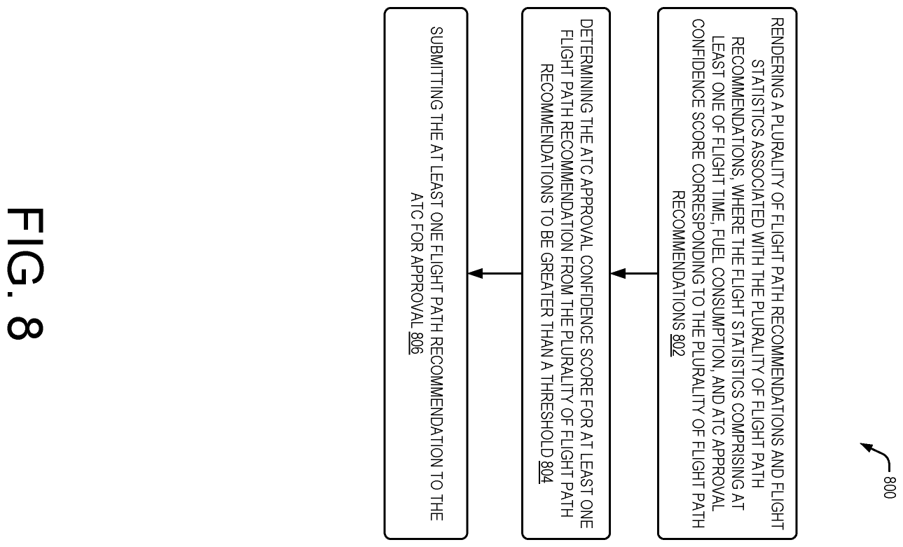

FIGS. 7 and 8 illustrate methods for obtaining ATC approval for a flight path recommendation, in accordance with examples of the present subject matter. The order in which the methods are described is not intended to be construed as a limitation, and any number of the described method blocks may be combined in any order to implement the methods, or an alternative method. Further, the methods 700 and 800 may be implemented by processing resource or computing device(s) through any suitable hardware, non-transitory machine-readable instructions, or combination thereof.

It may also be understood that methods 700 and 800 may be performed by programmed computing devices, such as the flight path recommendation system 102, as depicted in FIG. 3. Furthermore, the methods 700 and 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 700 and 800 are described below with reference to the flight path recommendation system 102, as described above; other suitable systems for the execution of these methods may also be utilized. Additionally, implementation of the method is not limited to such examples.

In FIG. 7, at block 702, the plurality of flight path recommendations and flight path parameters associated with the plurality of flight path recommendations may be rendered. The flight path parameters may include at least one of flight time, fuel consumption, ATC approval confidence score corresponding to the plurality of flight path recommendations. In an example, the ATC approval confidence score may be indicative of chances of approval of the flight path recommendation by the ATC. In an example, the plurality of flight path recommendations and flight path parameters associated with the plurality of flight path recommendations may be rendered by the analysis engine 204.

At block 704, a user selection of the at least one flight path recommendation from the plurality of flight path recommendations may be received. In an example, the user selection for the at least one flight path recommendation may be received by the analysis engine 204.

At block 706, the at least one flight path recommendation may be submitted to the ATC for approval. In an example, the at least one flight path recommendation may be submitted to the ATC for approval by the analysis engine 204.

In FIG. 8, at block 802, the plurality of flight path recommendations and flight path parameters associated with the plurality of flight path recommendations may be rendered. The flight path parameters may include at least one of flight time, fuel consumption, and ATC approval confidence score corresponding to the plurality of flight path recommendations. Further, the ATC approval confidence score may be indicative of chances of approval of the flight path recommendation by the ATC. In an example, the plurality of flight path recommendations and flight path parameters associated with the plurality of flight path recommendations may be rendered by the analysis engine 204.

At block 804, the ATC approval confidence score for at least one flight path recommendation from the plurality of flight path recommendations may be determined to be greater than a threshold. In an example, the ATC approval confidence score for the at least one flight path recommendation may be determined to be greater than the threshold by the analysis engine 204.

At block 806, the at least one flight path recommendation may be submitted to the ATC for approval. In an example, the at least one flight path recommendation may be submitted to the ATC for approval by the analysis engine 204.

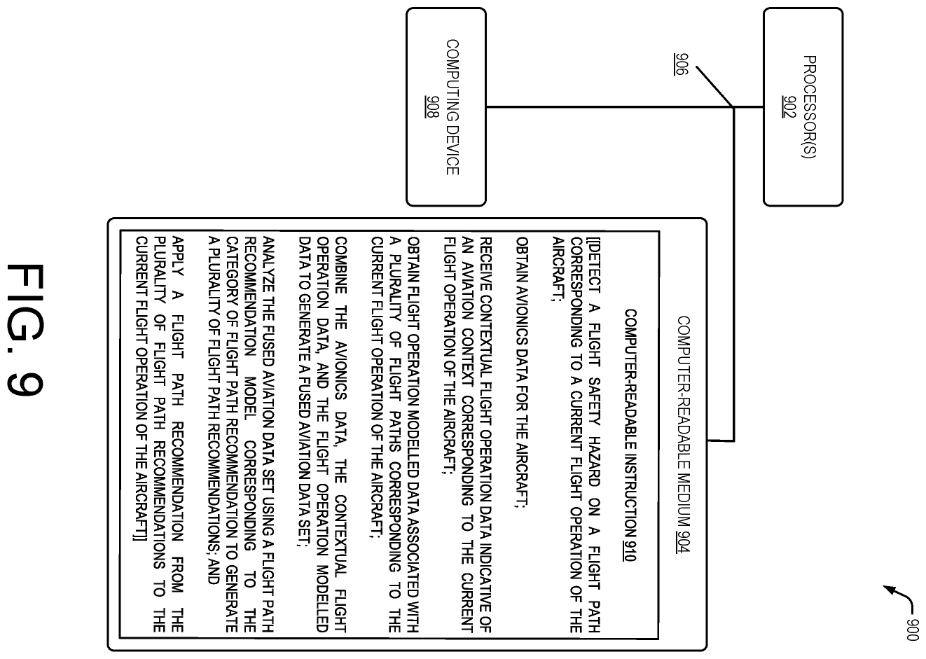

FIG. 9 illustrates a non-transitory computer-readable medium for generating flight path recommendations for an aircraft, in accordance with an example of the present subject matter.

In an example, the computing environment 900 includes processor 902 communicatively coupled to a non-transitory computer readable medium 904 through communication link 906. In an example implementation, the computing environment 900 may be for example, the flight path recommendation system 102. In an example, the processor 902 may have one or more processing resources for fetching and executing computer-readable instructions from the non-transitory computer readable medium 904. The processor 902 and the non-transitory computer readable medium 904 may be implemented, for example, in the flight path recommendation system 102.

The non-transitory computer readable medium 904 may be, for example, an internal memory device or an external memory. In an example implementation, the communication link 906 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 904 includes a set of computer readable instructions 910 which may be accessed by the processor 902 through the communication link 906 and subsequently executed for generating the flight path recommendations for the aircraft. The processor(s) 902 and the non-transitory computer readable medium 904 may also be communicatively coupled to a computing device 908 over the network.

Referring to FIG. 9, in an example, the non-transitory computer readable medium 904 includes computer readable instructions 910 that cause the processor 902 to detect a flight safety hazard on a flight path corresponding to a current flight operation of the aircraft. The flight safety hazard may be indicative of a condition or an event that has the potential to cause harm or disrupt safe flight operations. Examples of the flight safety hazards may include, but are not limited to, thunderstorms, turbulence, fog and low visibility, hurricanes and tornadoes, volcanic ash, bird strikes, runway contamination, and air traffic congestion.

The instructions 910 may further cause the processor 902 to obtain avionics data for the aircraft. In an example, the instructions 910 may cause the processor 902 to obtain the avionics data from avionics systems available onboard the aircraft. In the example, the instructions 910 may cause the processor 902 to obtain the avionics data in accordance with a category of the flight path recommendation. Further, the category of the flight path recommendation may be determined based on the flight safety hazard.

Thereafter, the instructions 910 may cause the processor 902 to obtain contextual flight operation data reflecting the aviation context corresponding to the current flight operation of the aircraft. In an example, the instructions 910 may cause the processor 902 to obtain the contextual flight operation data from at least one aviation cloud service. Further, the contextual flight operation data may be obtained in accordance with the category of the flight path recommendation.

The instructions 910 may then cause the processor 902 to combine the avionics data, the contextual flight operation data, and the flight operation modelled data to generate a fused aviation data set. Thereafter, the instructions 910 may cause the processor 902 to analyze the fused aviation data set using a flight path recommendation model corresponding to the category of flight path recommendation to generate a plurality of flight path recommendations. In an example, the flight path recommendation model may be trained based on the historical flight operations data related to the category of flight path recommendation.

Subsequently, the instructions 910 may cause the processor 902 to apply a flight path recommendation from the plurality of flight path recommendations to the current flight operation of the aircraft.

In an example, prior to applying the flight path recommendation to the current flight operation of the aircraft, the instructions 910 may cause the processor 902 to render the plurality of flight path recommendations and flight path parameters associated with the plurality of flight path recommendations. The flight path parameters may include at least one of flight time, fuel consumption, and ATC approval confidence score corresponding to the plurality of flight path recommendations. The ATC approval confidence score may be indicative of chances of approval of the flight path recommendation by the ATC. In the example, the instructions 910 may then cause the processor 902 to determine the ATC approval confidence score for the at least one flight path recommendation from the plurality of flight path recommendations to be greater than a threshold. Subsequently, the instructions 910 may cause the processor 902 to submit the at least one flight path recommendation to the ATC for approval. Once the at least one flight path recommendation is approved by the ATC, the instructions 910 may cause the processor 902 to apply the at least one flight path recommendation to the current flight operation of the aircraft.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method for generating flight path recommendations for an aircraft, the method comprising:
receiving an alternative flight path indication for generating a flight path recommendation corresponding to a current flight operation of the aircraft;
obtaining avionics data from avionics systems available onboard the aircraft, the avionics data being obtained in accordance with a category of flight path recommendation, and the category of the flight path recommendation being determined based on the alternative flight path indication;
receiving contextual flight operation data for the aircraft, the contextual flight operation data being indicative of an aviation context corresponding to the current flight operation of the aircraft, the contextual flight operation data being obtained from at least one aviation cloud service, and the contextual flight operation data being obtained in accordance with the category of the flight path recommendation;
obtaining flight operation modelled data associated with a plurality of flight paths corresponding to the current flight operation of the aircraft, the flight operation modelled data being obtained from at least one avionics digital clone of the avionics systems;
combining the avionics data, the contextual flight operation data, and the flight operation modelled data to generate a fused aviation data set;
analyzing the fused aviation data set using a flight path recommendation model corresponding to the category of flight path recommendation to generate a plurality of flight path recommendations, the flight path recommendation model being trained based on historical flight operations data related to the category of flight path recommendation; and
applying a flight path recommendation from the plurality of flight path recommendations to the current flight operation of the aircraft.

2. The method of claim 1, wherein the category of the flight path recommendation comprises at least one of flight safety hazard avoidance advisory, shortcut advisory, and fuel savings advisory.

3. The method of claim 1, wherein the alternative flight path indication is a user input.

4. The method of claim 1, wherein the alternative flight path indication is a flight safety hazard on a flight path corresponding to the current flight operation of the aircraft.

5. The method of claim 3, further comprising rendering the plurality of flight path recommendations and flight path parameters associated with the plurality of flight path recommendations, the flight path parameters comprising at least one of flight time, fuel consumption, and Air Traffic Controller (ATC) approval confidence score corresponding to the plurality of flight path recommendations.

6. The method of claim 5, further comprising:
receiving a user selection for at least one flight path recommendation from the plurality of flight path recommendations; and
submitting the at least one flight path recommendation to the ATC for approval.

7. The method of claim 5, further comprising:
determining the ATC approval confidence score for at least one flight path recommendation from the plurality of flight path recommendations to be greater than a threshold; and
submitting the at least one flight path recommendation to the ATC for approval.

8. The method of claim 1, wherein obtaining the avionics data comprises:
identifying an avionics Application Programming Interface (API) mashup corresponding to the category of the flight path recommendation, wherein the avionics API mashup is generated by clustering avionics APIs based on processing of API information for a plurality of APIs; and
employing the avionics API mashup for retrieving the avionics data from the avionic systems.

9. The method of claim 1, wherein obtaining the contextual flight operation data comprises:
identifying a cloud API mashup corresponding to the category of the flight path recommendation, wherein the cloud API mashup is generated by clustering APIs based on processing of API information for a plurality of APIs; and
employing the cloud API mashup for retrieving the contextual flight operation data.

10. The method of claim 1, wherein training the flight path recommendation model comprises:
identifying a cloud API mashup corresponding to the category of the flight path recommendation, wherein the cloud API mashup is generated by clustering APIs based on processing of API information for a plurality of APIs;
employing the cloud API mashup for retrieving the historical flight operations data from a plurality of data sources containing historical flight operations data associated with flight operations corresponding to a plurality of aircrafts; and
training the flight path recommendation model based on the historical flight operations data related to the category of flight path recommendation.

11. A flight path recommendation system comprising:
an interaction engine to:
receive a user input for generating a flight path recommendation corresponding to a current flight operation of the aircraft, the user input comprising a category of the flight path recommendation;
obtain avionics data from avionics systems available onboard the aircraft, the avionics data being obtained in accordance with the category of the flight path recommendation;
receive contextual flight operation data for the aircraft, the contextual flight operation data being indicative of an aviation context corresponding to the current flight operation of the aircraft, the contextual flight operation data being obtained from at least one aviation cloud service, and the contextual flight operation data being obtained in accordance with the category of the flight path recommendation; and
obtain flight operation modelled data associated with a plurality of flight paths corresponding to the current flight operation of the aircraft, the flight operation modelled data being obtained from at least one avionics digital clone of the avionics systems;
an analysis engine coupled to the detection engine to:
combine the avionics data, the contextual flight operation data, and the flight operation modelled data to generate a fused aviation data set; and
analyze the fused aviation data set using a flight path recommendation model corresponding to the category of flight path recommendation to generate a plurality of flight path recommendations, the flight path recommendation model being trained based on the historical flight operations data related to the category of flight path recommendation; and
flight path modification engine coupled to the analysis engine to apply a flight path recommendation from the plurality of flight path recommendations to the current flight operation of the aircraft.

12. The flight path recommendation system of claim 11, wherein the category of the flight path recommendation comprises at least one of shortcut advisory, weather hazard avoidance advisory, and flight altitude advisory.

13. The flight path recommendation system of claim 11, wherein the analysis engine is to render the plurality of flight path recommendations and flight path parameters associated with the plurality of flight path recommendations, the flight path parameters comprising at least one of flight time, fuel consumption, and Air Traffic Controller (ATC) approval confidence score corresponding to the plurality of flight path recommendations.

14. The flight path recommendation system of claim 13, wherein the analysis engine is to:
receive a user selection for at least one flight path recommendation from the plurality of flight path recommendations; and
submit the at least one flight path recommendation to the ATC for approval.

15. The flight path recommendation system of claim 11, wherein to obtain the avionics data, the analysis engine is to:
identify an avionics API mashup corresponding to the category of the flight path recommendation, wherein the avionics API mashup is generated by clustering avionics APIs based on processing of API information for a plurality of avionics APIs; and
employ the avionics API mashup for retrieving the avionics data.

16. The flight path recommendation system of claim 11, wherein to train the flight path recommendation model, the analysis engine is to:
identify a cloud API mashup corresponding to the category of the flight path recommendation, wherein the API mashup is generated by clustering APIs based on processing of API information for a plurality of APIs;
employ the cloud API mashup for retrieving the historical flight operations data from a plurality of data sources containing historical flight operations data associated with flight operations corresponding to a plurality of aircrafts; and
train the flight path recommendation model based on the historical flight operations data related to the category of flight path recommendation.

17. The flight path recommendation system of claim 11, wherein to obtain the contextual flight operation data, the analysis engine is to:
identify a cloud API mashup corresponding to the category of the flight path recommendation, wherein the cloud API mashup is generated by clustering APIs based on processing of API information for a plurality of APIs; and
employ the cloud API mashup for retrieving the contextual flight operation data.

18. A non-transitory computer readable medium comprising computer-readable instructions that when executed cause a processing resource of a computing device to:
detect a flight safety hazard on a flight path corresponding to a current flight operation of the aircraft;
obtain avionics data from avionics systems available onboard the aircraft, the avionics data being obtained in accordance with a category of the flight path recommendation, and the category of the flight path recommendation being determined based on the flight safety hazard;
receive contextual flight operations data from at least one aviation cloud service, the contextual flight operation data being indicative of an aviation context corresponding to the current flight operation of the aircraft, and the contextual flight operations data being obtained in accordance with the category of the flight path recommendation;
obtain flight operation modelled data associated with a plurality of flight paths corresponding to the current flight operation of the aircraft, the flight operation modelled data being obtained from at least one avionics digital clone of the avionics systems;
combine the avionics data, the contextual flight operation data, and the flight operation modelled data to generate a fused aviation data set;
analyze the fused aviation data set using a flight path recommendation model corresponding to the category of flight path recommendation to generate a plurality of flight path recommendations, the flight path recommendation model being trained based on the historical flight operations data related to the category of flight path recommendation; and
apply a flight path recommendation from the plurality of flight path recommendations to the current flight operation of the aircraft.

19. The non-transitory computer readable medium of claim 18, further comprising the instructions to render the plurality of flight path recommendations and flight path parameters associated with the plurality of flight path recommendations, the flight path parameters comprising at least one of flight time, fuel consumption, and Air Traffic Controller (ATC) approval confidence score corresponding to the plurality of flight path recommendations.

20. The non-transitory computer readable medium of claim 18, further comprising the instructions to:
determine the ATC approval confidence score for the at least one flight path recommendation from the plurality of flight path recommendations to be greater than a threshold; and
submit the at least one flight path recommendation to the ATC for approval.
